(19) United States
(12) Patent Application Publication
(10) Pub. No.: US 2023/0311085 A1
(43) Pub. Date: Oct. 5, 2023

(54) Process Gas Dividing System and Use of the Process Gas Dividing System

(71) Applicant: Glatt Ingenieurtechnik Gesellschaft mit beschränkter Haftung, Weimar (DE)

(72) Inventors: Frank Ohlendorf, Erfurt (DE); Arne Teiwes, Weimar (DE); Louis Friedrich, Bienstädt (DE); Michael Jacob, Weimar (DE)

(21) Appl. No.: 17/915,631

(22) PCT Filed: Mar. 25, 2021
(86) PCT No.: PCT/EP2021/057709

§ 371 Date: Mar. 3, 2023

(30) Foreign Application Priority Data
Mar. 31, 2020 (DE) 10 2020 204 197.0

(51) Int. Cl. B01J 4/00

(52) U.S. Cl. CPC B01J 4/002; B01J 2204/002; B01J 2204/005

(57) ABSTRACT

A process gas dividing system including a process gas dividing device as well as to use of a process gas dividing system in a reactor system for the production and/or treatment of particles in an oscillating process gas stream, in particular a pulsation reactor.

### CROSS-REFERENCE TO RELATED APPLICATIONS

This application is the United States national phase of International Application No. PCT/EP2021/057709 filed Mar. 25, 2021, and claims priority to German Patent Application No. 10 2020 204 197.0 filed Mar. 31, 2020, the disclosures of which are hereby incorporated by reference in their entireties.

### BACKGROUND

### Field

The invention relates to a process gas dividing system comprising a process gas dividing device having a process gas inflow that has a process gas inflow inlet, a process gas inflow outlet, a process gas inflow longitudinal center axis, and a process gas 5 inflow cross-sectional surface, having a process gas distributor that has a process gas distributor longitudinal center axis, a process gas distributor cross-sectional surface, a process gas distributor inlet arranged on a first end face, and a plurality of process gas distributor outlets arranged on a second end face, and having a number of process gas outflow units that corresponds to the plurality of the process gas distributor outlets, wherein each process gas outflow unit comprises a process gas outflow that has a process gas outflow inlet, a process gas outflow outlet, a process gas outflow longitudinal center axis, and a process gas outflow cross-sectional surface, and wherein the process gas inflow is connected with the first end face of the process gas distributor, and the second end face of the process gas distributor is connected with the process gas outflows of the process gas outflow units, in such a manner that a continuous flow path is formed, in each instance.

### Description of Related Art

Systems for distribution of a process gas stream have been known for a long time.

It is a disadvantage of these systems that the process gas is not optimally divided up into partial process gas streams by means of the systems that are already known.

### SUMMARY

It is therefore the task of the invention to make available a process gas dividing system, wherein the process gas stream that flows into the process gas dividing system is optimally divided up into individual process gas streams.

This task is accomplished, in the case of a process gas dividing system of the type stated initially, in that the process gas outflows of the process gas outflow units, which are arranged on the second end face, are arranged with uniform distribution in the circumference direction, that each process gas outflow longitudinal center axis of the process gas outflows has the same radial distance from the process gas distributor longitudinal center axis, and that each process gas outflow has the same process gas outflow cross-sectional surface. By means of the advantageous geometric configuration of the process gas dividing system, the result is achieved that the same process gas outflow cross-sectional surfaces, the same radial distances of the process gas outflows from the process gas distributor longitudinal center axis, and the same flow profiles occur in the process gas dividing system. As a result, an optimal equal distribution of the process gas that enters into the process gas dividing system by way of the process gas inflow, among the plurality of process gas outflows, is achieved in the process gas dividing system.

According to an advantageous embodiment of the process gas dividing system, in this regard, the process gas outflows all have the same length. By means of the same lengths of the process gas outlets, further uniformity of the flow profiles and of the pressure loss produced by way of the process gas dividing system is achieved.

In accordance with an additional advantageous further development of the process gas dividing system, the process gas dividing system has a flow channel system, wherein it is practical if each process gas outflow unit has a flow channel. By means of the flow channel system, the connection to a reactor of a reactor system, which reactor has a reaction space, in each instance, is produced.

Preferably the flow channels are configured as a pipe connection or hose connection. In this way, for example, a very flexible connection of the reactors is possible. It is further preferred if each flow channel is arranged downstream from a process gas outflow, specifically to this outflow. Particularly preferably, the flow channels all have the same length. The same length of the flow channels of the flow channel system brings about the result that each flow channel has the same pressure loss, and therefore the same optimal flow profiles occur in the respective flow channels.

According to a further advantageous embodiment of the process gas dividing system, at least one fitting is arranged in the flow channels after a flow channel path, in each instance, wherein the at least one fitting arranged in the flow channels is the same as the others, and the flow channel paths all have the same length. Preferably the fittings are configured as continuous gas volume stream regulation devices. Preferably a sliding gate valve, regulating valve, regulating cock or an iris shutter that can be regulated, for example is built in as the fitting. In this regard, the aforementioned fittings have a regulation precision of less than or equal to 3%, preferably of less than or equal to 2%, particularly preferably of less than or equal to 1%, and most preferably of less than or equal to 0.5%.

According to an additional advantageous embodiment of the process gas dividing system, a distance projected onto the first or second end face of the process gas distributor, between the process gas inflow longitudinal center axis and the process gas outflow longitudinal center axis of a process gas outflow, is greater than or equal to the sum of the process gas inflow radius and the corresponding process gas outflow radius of a process gas outflow. In this way, the result is achieved that a deflection of the process gas takes place in the process gas dividing system.

According to an additional advantageous further development of the process gas dividing system, the process gas inflow cross-sectional surface is greater than or equal to the process gas outflow cross-sectional surface of each process gas outflow. In this way, the process gas stream experiences a first deflection and a reduction in the process gas velocity at the transition from the process gas inflow to the process gas distributor, and subsequently, at the transition from the process gas distributor to the process gas outflow, it experiences a second deflection and an increase in the process gas velocity.

According to a further advantageous embodiment of the process gas dividing system, the process gas inflow cross-sectional surface and each process gas outflow cross-sectional surface of the process gas outflows is/are configured to be circular. As a result, the possibility exists of producing the process gas dividing system in a simple manner, by using cylindrical pipe pieces that have a different cross-sectional surface.

According to an additional advantageous embodiment of the process gas dividing system, a process gas inflow outlet surface and a process gas distributor inlet surface are configured to have the same size and to be congruent and/or a process gas distributor outlet surface and a process gas outflow inlet surface are configured to have the same size and to be congruent. As a result, no process gas backs up in the transition regions between the process gas inflow and process gas distributor or between the process gas distributor and the process gas outflow, so that the process gas stream experiences only the necessary pressure loss.

According to an additional advantageous embodiment of the process gas dividing system, a diffuser is arranged between the process gas inflow and process gas distributor and/or a nozzle is arranged between the process gas distributor and each process gas outflow. Preferably the diffuser widens continuously in the flow direction of the process gas and/or the nozzle narrows continuously in the flow direction of the process gas. Furthermore, preferably the diffuser and the nozzle have a different length in terms of their corresponding longitudinal center axis. By means of the inclusion of a diffuser between the process gas inflow and process gas distributor or of a nozzle between the process gas distributor and each process gas outflow, the kinetic energy of the process gas stream is converted to pressure energy or vice versa, wherein such a conversion preferably takes place by means of a continuous widening of the flow cross-section. This can be implemented geometrically in different ways, for example by means of a diffuser configured conically or in the shape of a trumpet bell or a nozzle configured conically or in the shape of a trumpet bell.

According to a further advantageous embodiment of the process gas dividing system, the process gas dividing system, in particular the process gas distributor is configured as a cavity. The process gas dividing system is thereby configured to be hollow on the inside, i.e., it is empty and, for example, no filter element or the like is arranged in it, so that the process gas can flow through the process gas dividing system without disruption.

The process gas dividing system according to one of the preceding claims is preferably used in a reactor system for the production and/or treatment of particles in an oscillating process gas stream, in particular a pulsation reactor. Preferably a process gas dividing device is arranged in the reactor system, upstream from the at least one reactor, so that at least one process gas feed line configured as a flow channel is assigned to each reactor of the reactor unit. Preferably each process gas feed line has a process gas volume stream regulation device. Each process gas feed line is configured, in particular, in such a manner that each flow channel has a pressure loss between the process gas dividing device and a reactor process gas inlet, wherein the process loss in each flow channel is essentially the same. By means of the aforementioned measures, a uniform distribution of the partial process gas streams in the reactor system is set.

### BRIEF DESCRIPTION OF THE DRAWINGS

In the following, the invention will be explained in greater detail using the attached drawing, which shows in

FIG. 1 a sectional representation of a first embodiment of a preferred process gas dividing system,

FIG. 2 a top view of the reference plane D of the first embodiment of the preferred process gas dividing system, oriented normal to the process gas inflow longitudinal center axis,

FIG. 3 a sectional representation of a second embodiment of a preferred process gas dividing system, and

FIG. 4 a schematic representation of a reactor system that uses the process gas dividing system and is configured as an oscillating system.

### DETAILED DESCRIPTION

If no information to the contrary is stated, the following description relates to all the embodiments of a process gas dividing system 1 illustrated in the drawing.

The process gas dividing system 1 comprises a process gas dividing device 2 having a process gas inflow 3, having a process gas distributor 4, and having a plurality of process gas outflow units 5.

The process gas inflow 3 has a process gas inflow inlet 6, a process gas inflow outlet 7, a process gas inflow longitudinal center axis A-A, and a process gas inflow cross-sectional surface 8.

The process gas distributor 4 has a process gas distributor longitudinal center axis B-B, a process gas distributor cross-sectional surface 9, a process gas distributor inlet 11 arranged on a first end face 10, and a plurality of process gas distributor outlets 13 arranged on a second end face 12.

Each process gas outflow unit 5 comprises a process gas outflow 17 that has a process gas outflow inlet 14, a process gas outflow outlet 15, a process gas outflow longitudinal center axis C-C, and a process gas outflow cross-sectional surface 16, as well as, in particular, a flow channel 18. The flow channels 18 form a flow channel system 19. It is practical if each process gas outflow unit 5 has precisely one flow channel 18, wherein each flow channel 18 is assigned to an individual process gas outflow 17 and arranged downstream specifically on this process gas outflow 17. Preferably the flow channels 18 are configured as pipe connections or hose connections.

The process gas inflow 3 is connected with the first end face 10 of the process gas distributor 4, and the second end face 12 of the process gas distributor 4 is connected with the process gas outflows 17 of the process gas outflow units 5, in such a manner that a continuous flow path 21 is formed, in each instance. In this regard, the number of process gas outflow units 5 that have a process gas outflow 17 corresponds to the plurality of the process gas distributor outlets 13. The process gas dividing system 1 brings about a division of the process gas PG that flows into the process gas dividing device 2, into partial process gas streams 22.

The process gas outflows 17 of the process gas outflow units 5 that are arranged on the second end face 12 are arranged to be uniformly distributed in the circumference direction, wherein each process gas outflow longitudinal center axis C-C of the process gas outflows 17 has the same radial distance 23 from the process gas distributor longitudinal center axis B-B, and each process gas outflow 17 has the same process gas outflow cross-sectional surface 16.

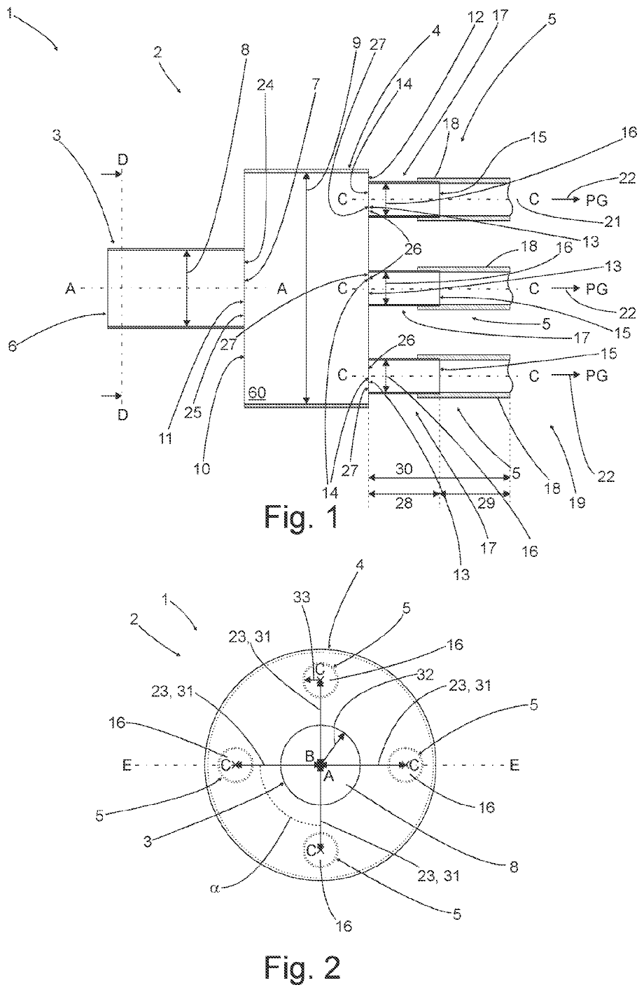

FIG. 1 shows a sectional representation of a first embodiment of a preferred process gas dividing system 1. The first embodiment of the process gas dividing system 1 has a process gas inflow 3, a process gas distributor 4, and a plurality of process gas outflow units 5, wherein the process gas dividing system 1 is configured as a cavity 60.

The process gas inflow longitudinal center axis A-A corresponds, in the first embodiment of the process gas dividing device 2 of the process gas dividing system 1, to the process gas distributor longitudinal center axis B-B.

In the process gas dividing device 2, a process gas inflow outlet surface 24 and a process gas distributor inlet surface 25 are configured to have the same size and to be congruent, for one thing, and for another thing a process gas distributor outlet surface 26 and a process gas outflow inlet surface 27 are configured to have the same size and to be congruent.

In the first embodiment, the process gas dividing device 2 comprises four process gas outflow units 5. In other embodiments, not shown, the number of process gas outflow units 5 is variable and can be, for example, two, three, four, five, six, seven, eight, nine, ten, eleven, twelve or more process gas outflow units 5, which are arranged on the process gas distributor 4 of the process gas dividing device 2. In particular, the process gas outflows 17 of the four process gas outflow units 5 have the same length 28, and the corresponding flow channels 18, which are configured as a hose connection, all have the same length 29, so that the process gas outflow units 5 all have the same length 30.

In FIG. 2, a top view of the reference plane D of the first embodiment of the preferred process gas dividing system 1, oriented normal to the process gas inflow longitudinal center axis A-A, is shown.

In the first embodiment, the process gas inflow cross-sectional surface 8 is greater than the process gas outflow cross-sectional surface 16 of the respective process gas outflows 17 of the process gas outflow unit 5. Furthermore, not only the process gas inflow cross-sectional surface 8 but also each process gas outflow cross-sectional surface 16 of the process gas outflow units 5 that have the process gas outflows 17 are configured to be circular.

The four process gas outflows 17 of the process gas outflow units 5 that are arranged on the second end face 12 are arranged with a uniform distribution in the circumference direction. The angle α between two process gas outflow units 5 is therefore 90°. Each process gas outflow longitudinal center axis C-C of the process gas outflows 17 of the process gas outflow units 5 has the same radial distance 23 from the process gas distributor longitudinal center axis B-B, and each process gas outflow 17 has the same process gas outflow cross-sectional surface 16.

Furthermore, the distance 31 between the process gas inflow longitudinal center axis A-A and the corresponding process gas outflow longitudinal center axis C-C of a process gas outflow 17, projected onto the first end face 10 of the process gas distributor 4, is greater than the sum of the process gas inflow radius 32 of the process gas inflow 3 and a corresponding process gas outflow radius 33 of the process gas outflow 17.

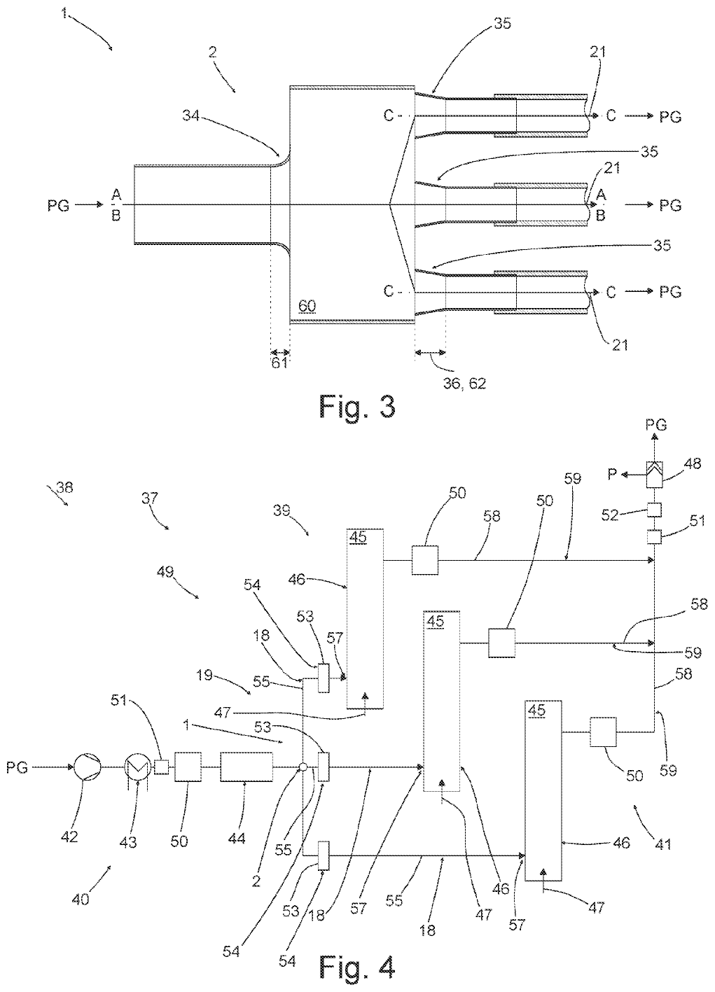

FIG. 3 shows a sectional representation of a second embodiment of a preferred process gas dividing system 1.

In contrast to the first embodiment shown in FIGS. 1 and 2, the process gas dividing device 2 of the second embodiment has a diffuser 34 that widens continuously in the flow direction of the process gas PG and is shaped in the form of a trumpet bell, between the process gas inflow 3 and process gas distributor 4. Furthermore, a nozzle 35 that narrows continuously in the flow direction of the process gas PG is arranged between the process gas distributor 4 and each process gas outflow 17 of the corresponding process gas outflow unit 5.

The diffuser 34 and the nozzles 35 have a different length 61, 62 in their corresponding longitudinal center axis A-A and C-C, respectively. The nozzles 35, in contrast, all have the same length 36.

The flow channels 18 of the flow channel systems 19 are configured as pipelines.

It is practical if a reactor system 38 for the production and/or treatment of particles P in an oscillating process gas stream, in particular a pulsation reactor, has the process gas dividing system 1. The process gas dividing system 1 has a process gas dividing device 2, having a process gas inflow 3 that has a process gas inflow inlet 6, a process gas inflow outlet 7, a process gas inflow longitudinal center axis A-A, and a process gas inflow cross-sectional surface 8, having a process gas distributor 4 that has a process gas distributor longitudinal center axis B-B, a process gas distributor cross-sectional surface 9, a process gas distributor inlet 11 arranged on a first end face 10 and a plurality of process gas distributor outlets 13 arranged on a second end face 12, and having a number of process gas outflow units 5 that corresponds to the plurality of the process gas distributor outlets 13, wherein each process gas outflow unit 5 comprises a process gas outflow 17 that has a process gas outflow inlet 14, a process gas outflow outlet 15, a process gas outflow longitudinal center axis C-C, and a process gas outflow cross-sectional surface 16, and wherein the process gas inflow 3 is connected with the first end face 10 of the process gas distributor 4, and the second end face 12 of the process gas distributor 4 is connected with the process gas outflows 17 of the process gas outflow units 5, in such a manner that a continuous flow path 21 forms, in each instance, characterized in that the process gas outflows 17 of the process gas outflow units 5 that are arranged on the second end face 12 are arranged distributed uniformly in the circumference direction of the process gas distributor 4, each process gas outflow longitudinal center axis C-C of the process gas outflows 17 has the same radial distance 23 from the process gas distributor longitudinal center axis B-B, and each process gas outflow 17 has the same process gas outflow cross-sectional surface 16.

Preferably the process gas dividing system 1 of the reactor system 38 is configured in accordance with one of claims 2 to 15.

In FIG. 4, a schematic representation of a reactor system 38 that uses the process gas dividing system 1 and is configured as an oscillating system 37 for the production and/or treatment of particles in an oscillating process gas stream, in particular a pulsation reactor is shown.

The reactor system 38 has a reactor unit 39, which is preceded by a process gas feed unit 40 and followed by a process gas discharge unit 41.

The reactor system 38 comprises a process gas conveying device 42 and a heating device 43. The process gas PG that flows through the reactor system 38 enters into the reactor system 38 by way of the process gas feed unit 40, and is conveyed through the reactor system 38 by means of the process gas conveying device 42.

The process gas conveying device 42 is configured, for example, in particular as a radial ventilator, blower or compressor. The process gas conveying device 42 can be arranged, in particular, in the process gas feed unit 40, the process gas discharge unit 41 or, alternatively, both in the process gas feed unit 40 and in the process gas discharge unit 41. In the embodiment of the reactor system 38 shown as an example in FIG. 4, placement of the process gas conveying device 42 in the process gas feed unit 40 is shown. The placement of the process gas conveying device 42 is adapted to the conditions to be set in the reactor system 38, in particular with regard to shape, mass, and density of the starting substance.

The heating device 43 can be arranged upstream or downstream from a pulsation device 44. Placement upstream from the pulsation device 44 is preferred, since in the case of such placement the heating device 43 does not damp a resonance pressure amplitude in the reactor system 38. The placement of the heating device 43 decides the assignment of the heating device 43 to the reactor unit 39 or to the process gas feed unit 40. A heating device 43 arranged upstream from the pulsation device 44 is assigned to the process gas feed unit 40; a heating device 43 arranged downstream from the pulsation device 44 is assigned to the reactor unit 39.

Preferably the heating device 43 is configured as a convective gas heater, an electric gas heater, a plasma heater, a microwave heater, an induction heater or a radiation heater. It is less preferred for the heating device 43 to be configured as a burner that has a flame.

The process gas PG that flows through the reactor system 38 is warmed or heated to a production and/or treatment temperature by means of the heating device 43. The temperature for the production or thermal treatment of the at least one starting substance preferably lies between 100° C. and 3000° C., preferably at 240° C. to 2200° C., particularly preferably at 240° C. to 1800° C., very particularly preferably at 650° C. to 1800° C., most preferably at 700° C. to 1500° C.

A pulsation having a pulsation frequency and a pulsation pressure amplitude is imposed on the process gas PG that flows through the reactor system 38, by means of the pulsation device 44. The pulsation preferably has a pulsation pressure amplitude of 0.1 mbar to 350 mbar, particularly preferably of 1 mbar to 200 mbar, very particularly preferably of 3 mbar to 50 mbar, most preferably of 10 mbar to 40 mbar.

The pulsation frequency of the process gas PG can be set independently of the pulsation pressure amplitude. The pulsation frequency of the process gas PG that flows through the reactor system 38, pulsating due to the pulsation device 44, can also be adjusted, preferably in the frequency range of 1 Hz to 2000 Hz, preferably between 1 Hz to 500 Hz, particularly preferably between 40 Hz and 160 Hz.

The pulsation device 44 is configured as a pulsation device 44 that works without a flame. It is practical if the pulsation device 44 is configured as a compression module, in particular as a piston, or as a rotary vane or as a modified turnstile.

The reactor 46, which has a reaction space 45 and is assigned to the reactor unit 39, is formed downstream from the process gas feed unit 40. In the reaction space 45 of the reactor 46, a pulsating process gas PG that flows through the reactor system 38 and the reactor 46 is introduced into the starting substance by means of an application device 47.

The application device 47 is preferably configured for introduction of liquids or solids into the reaction space 45 of the reactor 46.

Liquids or liquid raw materials (precursors) can be introduced into the reaction space 45 preferably as a solution, suspension, melt, emulsion or as a pure liquid. The introduction of the liquid raw materials or liquids preferably takes place continuously. For the introduction of liquids into the reaction space 45 of the reactor 46 of the reaction unit 39, an application device 47 is preferably used, such as, for example, spray nozzles, feed pipes or droplet dispensers, which are configured, for example, as single-substance or multi-substance nozzles, pressure nozzles, nebulizers (aerosol) or ultrasound nozzles.

In contrast to this, for the introduction of solids, for example powders, granulates or the like, into the reactor 46, preferably into the reaction space 45 of the reactor 46, an application device 47 is preferably used, such as, for example, a double flap, a rotary feeder, a batching valve or an injector.

The introduction of the starting substance in the form of a liquid or of a solid can take place in or counter to the flow direction of the process gas PG that flows through the reactor system 38. Preferably the starting substance is introduced into the reactor system 38, preferably into the reaction space 45 of the reactor 46, using a carrier gas. The decision as to whether the starting substance is introduced into the reactor system 38 in or counter to the flow direction of the process gas depends decisively on the shape, mass, and density of the starting substance at a set average flow speed of the process gas PG. As a result, the possibility exists of also thermally treating starting substances that cannot be transported in the reactor system 38 by means of the process gas PG.

The starting substance is treated thermally in the treatment zone of the reactor 46, preferably in the reaction space 45, so that the particles P to be produced, preferably the inorganic or organic nano-particles, particularly preferably the nano-crystalline metal oxide particles, are formed. The region in which the starting substances are treated thermally is defined as the treatment zone.

The process gas discharge unit 41 that follows the reactor unit 39 comprises a separation device 48. The separation device 48, in particular a filter, preferably a hot gas filter, very particularly preferably a tubular, metal or fiberglass filter, a cyclone or a washer, separates the thermally treated particles P from the pulsating, hot process gas stream that flows through the reactor system 38. The particles P that are removed from the process gas stream are drawn off from the separation device 48 and processed further. If necessary, the particles P that have been thermally treated in the reactor system 38 are subjected to further subsequent treatment steps, such as, for example, suspension, grinding or calcination. The non-charged process gas PG is conducted away into the environment.

The dwell time of the one starting substance introduced into the reactor system 38, in particular into the reaction space 45 of the reactor 46, lies between 0.1 s and 25 s. Closed-cycle operation of the process gas PG is possible. If applicable, partial removal of the process gas PG from the circuit is also possible.

Furthermore, the reactor system 38, which has a static process gas pressure, is configured as an acoustic resonator 49, which has inherent resonance frequencies that each define a resonance state. The process gas PG can form a gas column that is capable of resonance in the reactor system 38, so that the resonator 49 can be excited by means of the pulsation frequency and/or the pulsation pressure amplitude of the pulsation that is generated by means of the pulsation device 44, and in the resonance state, the pulsation can be amplified to produce a resonance oscillation of the process gas PG that has a resonance frequency and a resonance pressure amplitude.

The process gas feed unit 40 and the process gas discharge unit 41 each comprise a pressure loss production device 50 that produces a pressure loss, wherein the pressure loss production devices 50 are configured in such a manner that optionally one of the resonance states of the resonator 49 can be set. The pressure loss production devices 50 limit a system 37 of the reactor system 38 that is capable of oscillation and oscillates in the operating state, geometrically and with regard to the process gas volume of the gas column that is formed and is capable of resonance. The pressure loss production devices 50 thereby prevent propagation of the resonance oscillation beyond the pressure loss production devices 50. The more limited the system 14 is, which is capable of oscillation or oscillates in the operating state, the more effective production and propagation of the resonance oscillation in the system 37 will be.

The process loss production devices 50 are arranged in the reactor system 38, in particular in the process gas feed unit 40 and the process gas discharge unit 41, so that their respective positions can be changed, wherein in the operating state, the pressure loss production devices 50 cannot be changed in terms of the position that has previously been set. In this way, it is ensured that the system 37, which oscillates in the operating state, does not change.

The pulsation device 44 of the reactor system 38 is configured for adapting the pulsation frequency and/or the pulsation pressure amplitude of the pulsation to one of the inherent resonance frequencies of the resonator 49, in such a manner that the selected resonance state can be achieved. Particularly preferably, the pulsation frequency or a whole-number multiple of it is set close to the resonance frequency of the resonator 49, so that the resonator 49 is excited and a resonance oscillation occurs in the system 37, which is capable of oscillation. By means of imposing a periodic pulsation onto the process gas, wherein in particular the pulsation frequency or a whole-number multiple of it is set close to the resonance frequency of the resonator 492, in a targeted manner, amplification of the resonance oscillation of the process gas, which has a resonance frequency and a resonance pressure amplitude, is achieved. In this way, the heat transfer and material transfer properties of the preferably hot process gas in the reactor system 38 are improved.

In the case of certain processes, it is advantageous to be able to set or regulate the static pressure in the reactor system. For this purpose, the reactor system 38, in particular the process gas feed unit 40 and the process gas discharge unit 41, has/have a process gas regulation device 51.

The pressure loss production devices 50 that limit the system 37, which is capable of oscillation or oscillates in the operating state, are arranged within the process gas regulation device 51. Upstream from the reactor unit 39, the process gas regulation device 51 is therefore arranged upstream from the pressure loss production devices 50, and downstream from the reactor unit 39, downstream from the pressure loss production devices 50. Without such a process gas regulation device 51, the static process gas pressure in the reactor system 38 corresponds to atmospheric pressure.

By means of adapting the static process gas pressure in the reactor system 38, an influence can be exerted on the properties of the acoustic resonator 49. Flow resistances, acoustic phenomena, and changes in the material properties of the process gas as well as of the starting substance applied to it can damp the resonance oscillation. The energy expenditure for resonance oscillation production is accordingly increased and/or the ability to regulate the resonance oscillation is influenced. In particular, the reactor system 38 can be adapted, in this way, to the factors that damp the resonance pressure amplitude of the resonance oscillation.

A higher static process gas pressure changes the acoustic properties of the resonator 49, for example to the effect that its inherent resonance frequencies shift. For this reason, excitation of the reactor system 38 is possible only by means of the imposition of other pulsation frequencies onto the process gas PG.

In addition, the pulsation pressure amplitude imposed on the process gas by means of the pulsation device 44, and thereby also the resonance pressure amplitude in the resonance state is amplified.

In addition, the reactor system 38 also has a process gas cooling segment 52, in particular a quenching apparatus, which is used to stop the reaction taking place in the reactor system 38 at a certain point in time and/or to adapt the process gas stream to a maximally permissible temperature of a subsequent separation device 48, in particular a filter. The process gas cooling segment 52, preferably the quenching apparatus, is arranged, here, in the process gas discharge unit 41, upstream from the separation device 48 that is configured as a filter.

To stop the reaction and/or to limit the temperature of the process gas stream to a maximally permissible temperature of a subsequent separation device, a cooling gas is mixed into the pulsating, hot process gas stream that flows through the reactor system 38, by way of the process gas cooling segment 52, preferably air, particularly preferably cold air or compressed air. The air mixed in by way of the process gas cooling segment 52 can be filtered or conditioned beforehand, if necessary, depending on the requirements. Furthermore, it is possible, alternatively to mixing in air or gas, to undertake injection of an evaporating liquid, for example of solvents or liquefied gases, but preferably of water.

The process gas cooling segment 52 arranged in the reactor system 38 can have fittings or is built into the reactor system 38 without fittings. Other gases, such as, for example, nitrogen (N₂), argon (Ar), other inert gases or noble gases or the like can also be used as a cooling gas.

Furthermore, it can be practical if a fitting 54 configured as a process gas volume stream regulation device 53 is arranged upstream from the at least one reactor 46. Preferably the process gas volume stream regulation device 53 is arranged downstream from the pulsation device 44. In the flow channels 18, which are configured as a process gas feed line 55, at least one fitting 54 is arranged, in each instance, after a flow channel path 56, wherein the at least one fitting 54 arranged in the flow channels 18 is the same as all the others, and the flow channel path 56 has the same length as all the others.

The process gas volume stream regulation device 53 is configured, in particular, as a sliding gate valve, regulating valve, regulating cock or an iris shutter that can be regulated. The process gas volume stream regulation device 53 has a regulation accuracy of less than or equal to 3%, preferably of less than or equal to 2%, particularly preferably of less than or equal to 1%, and most preferably of less than or equal to 0.5%. The process gas volume stream regulation, which demonstrates great regulation accuracy, is necessary so as to minimize or prevent feedback to the process gas volume stream caused by the resonance oscillation. In particular, great regulation precision of the process gas volume stream is necessary when using a process gas dividing device 2, so that the system 37, which is capable of oscillation or oscillates in the operating state can be operated in a sufficiently stable manner.

If the reactor unit 39, as shown in the embodiment, has a plurality of reactors 46, a process gas dividing device 2 is arranged upstream from the reactors 46, so that at least one flow channel 18, configured as a process gas feed line 55, is assigned to each reactor 46 of the reactor unit 39.

Preferably the process gas dividing device 2 of the process gas dividing system 1 is arranged downstream from the pulsation device 44, and each process gas feed line 55 has a process gas volume stream regulation device 53. Each process gas feed line 55 is configured in such a manner that each process gas feed line 55 has a pressure loss between the process gas dividing device 2 and a reactor inlet 57, wherein the pressure loss in each process gas feed line 55 is essentially the same. This result is achieved in that in particular the process gas feed lines 55 configured as flow channels 18 of the flow channel system 19 have the same length 29 and/or the same process gas feed line inside diameter and/or other fittings 54 that are the same.

Furthermore, the process gas discharge device 41 has a plurality of flow channels 59 that are configured as process gas discharge lines 58, which number at least corresponds to the plurality of reactors 46, wherein each process gas discharge line 58 has a pressure loss production device 50.

The process gas discharge lines 58 are brought together, and the particles P are separated from the process gas stream, preferably from the hot process gas stream by way of the separation device 48.

1. A process gas dividing system comprising
a process gas dividing device having a process gas inflow that has a process gas inflow inlet, a process gas inflow outlet, a process gas inflow longitudinal center axis, and a process gas inflow cross-sectional surface,
having a process gas distributor that has a process gas distributor longitudinal center axis, a process gas distributor cross-sectional surface, a process gas distributor inlet arranged on a first end face, and a plurality of process gas distributor outlets arranged on a second end face, and
having a number of process gas outflow units that corresponds to the plurality of the process gas distributor outlets,
wherein each process gas outflow unit comprises a process gas outflow that has a process gas outflow inlet, a process gas outflow outlet, a process gas outflow longitudinal center axis, and a process gas outflow cross-sectional surface, and
wherein the process gas inflow is connected with the first end face of the process gas distributor, and the second end face of the process gas distributor is connected with the process gas outflows of the process gas outflow units, in such a manner that a continuous flow path is formed, in each instance, wherein the process gas outflows of the process gas outflow units arranged on the second end face are arranged with uniform distribution in the circumference direction of the process gas distributor, that each process gas outflow longitudinal center axis of the process gas outflows has the same radial distance from the process gas distributor longitudinal center axis, and that each process gas outflow has the same process gas outflow cross-sectional surface.

2. The process gas dividing system according to claim 1, wherein the process gas outflows all have the same length.

3. The process gas dividing system according to claim 1, wherein the process gas dividing system has a flow channel system that forms flow channels, wherein each process gas outflow unit has a flow channel.

4. The process gas dividing system according to claim 3, wherein the flow channels are configured as a pipe connection or hose connection.

5. The process gas dividing system according to claim 3, wherein each flow channel is arranged downstream from a process gas outflow on this outflow.

6. The process gas dividing system according to claim 3, wherein the flow channels all have the same length.

7. The process gas dividing system according to claim 3, wherein at least one fitting is arranged in the flow channels after a flow channel path, in each instance, wherein the at least one fitting arranged in the flow channels are all the same and the flow channel paths are all the same length.

8. The process gas dividing system according to claim 1, wherein a distance between the process gas inflow longitudinal center axis and the process gas outflow longitudinal center axis of a process gas outflow, projected onto the first or second end face of the process gas distributor, is greater than or equal to the sum of the process gas inflow radius and a corresponding process gas outflow radius of a process gas outflow.

9. The process gas dividing system according to claim 1, wherein the process gas inflow cross-sectional surface is greater than or equal to the process gas outflow cross-sectional surface of each process gas outflow.

10. The process gas dividing system according to claim 1, wherein the process gas inflow cross-sectional surface, the process gas distributor cross-sectional surface, and each process gas outflow cross-sectional surface of the process gas outflow are configured to be circular.

11. The process gas dividing system according to claim 1, wherein a process gas inflow outlet surface and a process gas distributor inlet surface are configured to have the same size and to be congruent and/or a process gas distributor outlet surface and a process gas outflow inlet surface are configured to have the same size and to be congruent.

12. The process gas dividing system according to claim 1, wherein a diffuser is arranged between the process gas inflow and process gas distributor and/or a nozzle is arranged between the process gas distributor and each process gas outflow of a process gas outflow unit.

13. The process gas dividing system according to claim 10, wherein the diffuser widens continuously in the flow direction of the process gas and/or the nozzle narrows continuously in the flow direction of the process gas.

14. The process gas dividing system according to claim 9, wherein diffuser and nozzle have a different length in terms of their corresponding longitudinal center axis.

15. The process gas dividing system according to claim 1, wherein the process gas dividing system is configured as a cavity.

16. A method for the production and/or treatment of particles in an oscillating process gas stream using a process gas dividing system in a reactor system the process gas dividing system comprising:
a process gas dividing device having a process gas inflow that has a process gas inflow inlet, a process gas inflow outlet, a process gas inflow longitudinal center axis, and a process gas inflow cross-sectional surface,
having a process gas distributor that has a process gas distributor longitudinal center axis, a process gas distributor cross-sectional surface, a process gas distributor inlet arranged on a first end face, and a plurality of process gas distributor outlets arranged on a second end face, and
having a number of process gas outflow units that corresponds to the plurality of the process gas distributor outlets, wherein each process gas outflow unit comprises a process gas outflow that has a process gas outflow inlet, a process gas outflow outlet, a process gas outflow longitudinal center axis, and a process gas outflow cross-sectional surface, and
wherein the process gas inflow is connected with the first end face of the process gas distributor, and the second end face of the process gas distributor is connected with the process gas outflows of the process gas outflow units, in such a manner that a continuous flow path is formed, in each instance, wherein the process gas outflows of the process gas outflow units arranged on the second end face are arranged with uniform distribution in the circumference direction of the process gas distributor, that each process gas outflow longitudinal center axis of the process gas outflow has the same radial distance from the process gas distributor longitudinal center axis, and that each process gas outflow has the same process gas outflow cross-sectional surface, the method comprising:
introducing the oscillating process gas stream to the process gas dividing system; and
producing and/or treating the particles in the oscillating process gas stream.
